(19) United States
(12) Patent Application Publication
(10) Pub. No.: US 2024/0103996 A1
(43) Pub. Date: Mar. 28, 2024

(54) Method for Providing Information to a Plurality of Recipients

(71) Applicant: Robert Bosch GmbH, Stuttgart (DE)

(72) Inventor: Carsten Lindstedt, Frankfurt am Main (DE)

(21) Appl. No.: 18/462,933

(22) Filed: Sep. 7, 2023

(30) Foreign Application Priority Data
Sep. 13, 2022 (DE) 10 2022 209 551.0

(51) Int. Cl. G06F 11/34; G07C 5/00; G07C 5/12

(52) U.S. Cl. CPC G06F 11/3495; G07C 5/008; G07C 5/12

(57) ABSTRACT

A method for providing information to a plurality of recipients includes (i) providing product information to a backend, (ii) providing recipient information to the backend, (iii) providing usage information to the backend, (iv) providing a specification and the information by a sender, (v) determining the plurality of recipients based on the product information, the recipient information, the usage information, and the specification, and (vi) providing the information to the recipients determined.

This application claims priority under 35 U.S.C. § 119 to patent application no. DE 10 2022 209 551.0, filed on Sep. 13, 2022 in Germany, the disclosure of which is incorporated herein by reference in its entirety.

The disclosure relates to a method for providing information to a plurality of recipients that includes (i) providing product information to a backend, (ii) providing recipient information to the backend, (iii) providing usage information to the backend, (iv) providing a specification and the information by a sender, (v) determining the plurality of recipients based on the product information, the recipient information, the usage information, and the specification, and (vi) providing the information to the recipients determined. Advantageously, product-related information can be provided to the recipient, wherein the product related to it is the property of and/or used by the recipient.

The provision of the information can occur, for example, via a radio interface, for example a mobile telephone interface, or via the Internet, for example via email. Preferably, the provision of the information is via Internet server communication. A recipient is understood to mean a person, wherein the information is provided to the recipient via a technical device.

The provision of the information can be via a mobile terminal, for example a smartphone, a smartwatch, data goggles, in particular an HUD, or a computer, wherein the mobile terminal is coupled to and/or connected to the respective product. Alternatively or additionally, the information about the product may be provided, in particular via a display screen connected to the product, wherein the product is configured, for example, as a bicycle or as an electric bike. If the information is provided to the product, it preferably comprises a communication interface, preferably a radio interface, and a display unit, for example a display screen.

The product information is in particular related to a product that is in use by the recipient. The product is preferably configured as a motor-assisted vehicle. In the context of this application, a motor-assisted vehicle should, in particular, be understood to mean a vehicle that can be driven with a motor drive, in particular an electric motor drive, in addition to the muscle force of a driver. For example, the motor-assisted vehicle may be configured as an electric bike.

In the context of this application, the term “electric bike” is in particular intended to mean a bicycle having a drive unit for assisting the rider. The electric bike is preferably configured as an e-bike, a pedelec, a cargo bicycle, a folding bicycle, or the like. The drive unit has a motor, which can, for example, be designed as a mid-motor or as a hub motor. The motor is preferably designed as an electric motor. The drive unit is connected to an energy storage means for supplying power to the drive unit. The energy storage means is preferably designed as a battery pack and comprises a battery housing, which is preferably releasably connected to a frame of the bike. The electric bike comprises an electronic system comprising a control unit for controlling or regulating the electric bike. The electronic system preferably comprises a sensor unit, in which case the sensor unit can comprise, e.g., motion sensors, torque sensors, speed sensors, a GNSS receiver, magnetic sensors, or the like. The electric bike further comprises a communication interface for wirelessly connecting the electric bike to the mobile terminal, e.g., a smartphone and/or with a server via the Internet.

For example, the sender may be configured as a manufacturer, in particular a manufacturer of the product or a manufacturer of at least one component of the product, or as a service provider, in particular a service provider for the product or a service provider for at least one component of the product, or as a distributor, in particular a distributor for the product, or for at least one component or for at least one service for the product. For example, the information may be configured as a notice for a service interval for maintenance of the product or a component of the product, a notice for new products, new or alternative components for the product, and/or new service options or features for the product, a message from the manufacturer or distributor to the recipient, a notice for an upcoming event, etc.

Furthermore, it is proposed that the product information is provided by an electric bike or a preferably mobile terminal connected to a bicycle, in particular an electric bike. Advantageously, product-specific information can thereby be provided. The provision of the product information, the recipient information, and/or the usage information may be automatic, semi-automatic, or manual. The automatic provisioning may preferably be performed using a machine learning methodology, for example, by determining a defect by a machine learning algorithm and subsequently providing usage information to the backend in the form of defect information.

Furthermore, it is proposed that the product information comprises manufacturer information, dealer information, a bike ID, model information, year of manufacture, accessory information, electrical system information, and/or equipment information. Advantageously, an optimum determination of the recipient group can be ensured thereby.

In addition, it is proposed that the recipient information is provided by the electric bike or a preferably mobile terminal connected to a bicycle, in particular an electric bike. The provisioning may be automatic, semi-automatic, or manual. Advantageously, this may provide recipient-specific information.

Furthermore, it is proposed that the recipient information comprises a user ID. Advantageously, the recipient information, in particular the recipient information, the product information, and the usage information, can be associated with a recipient for shipment.

It is further proposed that the recipient information comprises physical information related to the recipient. The recipient information may comprise, by way of example, a height, a gender, an age group of the recipient. It is also conceivable that the recipient information comprises a location variable, such as a place of residence, a location or a preferred region of use of the product, a usage scenario such as a commuter, trails, etc. The recipient information may also include an interest variable of the recipient, for example, the recipient is interested in a new or alternative product or component of the product.

In addition, it is proposed that the usage information is configured as electric bike usage information and, in particular, comprises a usage duration, a frequency of use, a location of use, a mode of use, a maintenance frequency, and/or wear information. Advantageously, this can provide information specific to owners and/or users of electric bikes.

In addition, it is proposed that the usage information is configured as application software usage information and, in particular, comprises a frequency of use or a mode of use of application software of a mobile terminal. For example, the application software may be configured as an app for an electric bike that is stored and/or executed on a mobile terminal. It is also conceivable that the application software is configured as an email client. It is also conceivable that the usage information may be configured as feedback, wherein the feedback is provided by the recipient in response to information provided by the method. For example, the mode of use may be a usage response, such as whether the information is interacted with, in particular in the form of following a link or ignoring or expressing a disinterest by swiping the information away. The mode of use may also be a variable of how much time the recipient spends on the information.

Furthermore, it is proposed that the product information is substantially static and the usage information is substantially variable. The product information is thus structurally configured so that it does not change without changing the product, for example by replacing a component of the product or by accessories. The usage information is dynamically configured to change through usage of the product.

Furthermore, it is proposed that the determination of the recipients be made for at least two recipient groups, wherein the first recipient group comprises all user IDs and wherein the second recipient groups are restricted by the manufacturer information. Advantageously, this can optimize the identification of relevant recipients. Each recipient group preferably comprises at least 10 recipients, preferably at least 100 recipients. The recipient groups may overlap partially or completely. At least one user ID is assigned to each recipient, wherein a recipient can also have several bike IDs per user ID, for example, in that the recipient has or uses a plurality of electric bikes.

Furthermore, it is proposed that the determination of the recipient is made for an additional recipient group, the additional recipient group being restricted by the distributor information. Advantageously, this may restrict the recipient group to the distributor from whom the electric bike was purchased and/or the recipient has selected as the preferred distributor. The additional recipient group and the second recipient group may partially overlap with the second recipient group.

It is also proposed that the specification comprises a product specification, a recipient specification, and/or a usage specification. Advantageously, the recipient group may be optimally restricted as a result. The product specification in particular corresponds to product information provided by the sender, for example a specific manufacturer. The recipient specification corresponds in particular to recipient information provided by the sender, for example an age group between 25 and 40 years of age. The usage specification corresponds in particular to usage information provided by the sender, for example, at least weekly use of the electric bike of at least 30 km or at least 1,000 km ridden.

Furthermore, it is proposed that a send criterion be provided to the backend by the sender, wherein the sending of the information to the determined recipient occurs based on the send criterion. The provisioning is preferably via a frontend connected to the backend, for example via a web interface. Advantageously, the point in time at which the information is provided to the recipient can be optimally adjusted. The point in time may be static, wherein a static point in time is understood to mean that the information is provided to all recipients at essentially the same point in time. Preferably, the static point in time is adjusted to the respective time zone. It is also conceivable that the point in time may be dynamic, wherein dynamic is understood to mean that the information is provided to the recipients at different times, preferably under one condition. For example, the condition may be a presence in a region, a number of kilometers ridden with the bike, or an age of the bike.

It is further proposed that the information be displayed on a mobile terminal connected to an electric bike or on the electric bike. Advantageously, the information can thereby be provided directly and visibly.

### BRIEF DESCRIPTION OF THE DRAWINGS

Further advantages will become apparent from the description of the drawings hereinafter. The drawings, the description, and the claims contain numerous features in combination. The person skilled in the art will appropriately also consider the features individually and combine them to form further meaningful combinations.

The following are shown:

FIG. 1 a schematic view of a system for providing information to a plurality of recipients;

FIG. 2 a flow chart for a method for providing the information to a plurality of recipients;

FIG. 3 an exemplary web interface for the method according to FIG. 2.

### DETAILED DESCRIPTION

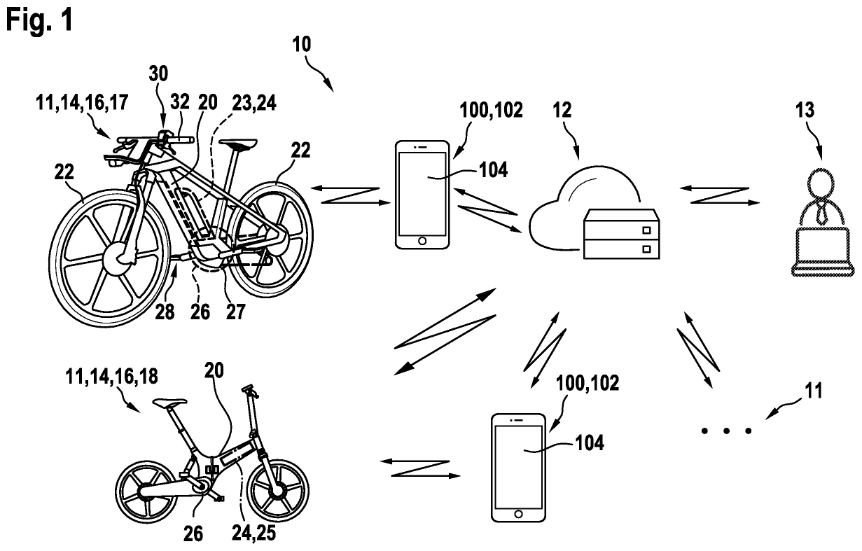

In FIG. 1, a system 10 for providing information to a plurality of recipients is schematically illustrated. The system 10 comprises at least one backend 12 and a plurality of products 11 that, for example, are configured as motor-assisted vehicles 14 in the form of electric wheels 16. In addition, the system 10 comprises at least one sender 13. The system 10 also comprises a front end 15 connected to the backend 12.

For example, the backend 12 is configured as a web server. The plurality of products 11 may be configured the same, but as exemplified, comprises products 11 that differ from each other. For example, two electric bikes 16 are shown, wherein the electric bikes 16 differ. The electric bikes 16 differ by way of example by the manufacturer and the type of bike. The electric bike 16 can be designed, for example, as a pedelec or an e-bike. Thus, the first electric bike 16 is, by way of example, configured as a full mountain bike 17 and the second electric bike 16, by way of example, as a folding bike 18. It would also be conceivable to have other types of bikes, such as hardtails, racing bikes, children's bikes, etc. It is also conceivable that the system 10 may have further products, for example bikes without electric drive.

The first electric bike 16 comprises a housing in the form of a frame 20 or a bike frame. Connected to the frame 20 are two wheels 22. In addition, the electric bike 16 comprises an energy storage means 24 in the form of an exchangeable battery pack 23. In addition, the electric bicycle 16 comprises a drive unit 26, which comprises an electric motor and/or an auxiliary motor. The electric motor is preferably configured as a permanent magnet-excited, brushless DC motor. The electric motor is designed, e.g., as a mid-drive motor, a hub motor or the like also being conceivable. The electric bike 16, in particular the drive unit 26 of the electric bike 16, is powered via the energy storage means 24. The energy storage means 24, by way of example, is configured to be attachable to the frame 20 from the outside.

The drive unit 26 comprises a control unit (not shown) designed to control or regulate the electric bike 16, in particular the electric motor. The electric bike 16 comprises a pedal crank 28. The pedal crank 28 comprises a pedal crankshaft (not shown). The control unit of the electric bike 16 is connected to a sensor unit (not shown). The sensor unit of the electric bike 16 comprises, by way of example, multiple sensor elements, such as a torque sensor and a magnetic sensor.

The control unit and the drive unit 26 having the electric motor and the pedal crankshaft are arranged within a drive housing 27 connected to the frame 20. The drive movement of the electric motor is preferably transmitted to the pedal crankshaft via a transmission (not shown), with the magnitude of the assistance by the drive unit 26 being controlled or regulated via the control unit. The control unit is designed to drive the drive unit 26 such that the driver of the electric bike 16 is assisted in pedaling. Preferably, the control unit can be operated by the driver so that the driver can set the assistance level.

The control unit and the sensor unit are associated with the electronic system (not shown) of the electric bike 16. The electronic system comprises, e.g., a printed groupboard on which are arranged a computing unit in the form of a CPU, a memory unit, and the sensor unit. The electronics are, for example, arranged entirely within the drive housing 27 of the drive unit 26. However, it is also conceivable that the electronics be only partially arranged in the drive housing 27 and that components of the electronics be arranged in other areas of the electric bike 16. In addition, an arrangement of the electronics outside the drive housing 27 is also conceivable.

The electric bike 16 also comprises, e.g., an on-board computer 30 arranged on a handlebar 32 of the electric bike 16. The on-board computer 30 is partially releasably formed with the electric bike 16. The on-board computer 30 comprises a display unit (not shown) designed to display information. The on-board computer 30 also comprises an operating element (not shown) via which the user or the driver can control the on-board computer 30 and/or the electric bike 16. The operating element is, by way of example, configured as a touch-sensitive screen, but it is also conceivable that the operating element is formed from knobs or buttons. The on-board computer 30 is connected to the control unit of the electric bicycle 16 such that information can be exchanged. For example, the display unit can display a speed determined by the control unit, a set assistance level of the electric motor, route information of a navigation unit, and a state of charge of the energy storage means 24.

The connection between the on-board computer 30 and the electronics of the electric bicycle 16 can take place via a wireless communication interface (not shown) of the electric bicycle 16 or in a wired manner. The electric bike 16 comprises a wireless communication interface. The wireless communication interface of the electric bike 16 is, by way of example, configured as a short-range radio interface in the form of a BLE (Bluetooth Low Energy) interface. Alternatively, other short-range radio interfaces are conceivable. Alternatively or additionally, it is also conceivable that the electric bike 16 comprises a long-range communication interface designed to connect the electric bike 16 to a server, e.g., a web server.

To connect the electric bike 16 to the backend 12, the electric bike 16 is connected to a mobile terminal 100. The connection is made via the short-range radio interface, for example. The connection is preferably via a pairing process in which the mobile terminal 100 is paired with the electric bike 16. The mobile terminal 100 is exemplarily configured as a smartphone 102.

The mobile terminal 100 comprises a wireless communication interface configured to connect the mobile terminal 100 to the electric bike 16 and to the backend 12. The wireless communication interface of the mobile terminal 100 comprises, for example, a BLE interface for connection to the electric bike 16 and a mobile radio interface for connection to the backend 12. Thus, the electric bike 16 may exchange data with the backend 12 via the mobile terminal 100. The mobile terminal 100 advantageously comprises a display screen 104 via which information can be displayed.

The second bike 16 is, by way of example, designed as a folding bike 18. As previously described, the second electric bike 16 also comprises a drive unit 26, which is powered by an energy storage means 24. The drive unit 26 of the second electric bike 16 corresponds, by way of example, to the drive unit 26 of the first electric bike 16. The energy storage means 24 is, by way of example, configured as an integrated battery pack 25 within a frame 20, in particular a lower tube, of the electric bike 16. The integrated battery pack 25 is configured as a fixed battery pack, which cannot be readily replaced by the user.

The second electric bike 16 comprises a wireless communication interface that, by way of example, comprises a short-range radio interface in the form of a BLE interface and a long-range radio interface in the form of a 5G radio interface. The short-range radio interface is preferably configured to connect to a mobile terminal 100, as previously described, wherein the mobile terminal 100 can in turn exchange data with the backend 12. The long-range radio interface of the electric bike 16 is preferably provided for direct connection to the backend 12, wherein in this context a direct connection is understood to mean a connection without a mobile terminal 100.

The system 10 further comprises a plurality of further products 11, wherein the products 11 may be from different manufacturers, different types, provided with different components, etc. The further products 11 each comprise a wireless communication interface for connection to the backend 12.

Each product 11, in particular each electric bike 16 of the system 10, is preferably associated with a user account. The user account is identifiable via a user ID. By way of example, the system comprises application software for the mobile terminal 100, the execution of which is coupled to a user account that can be created, for example, upon initial login by the owner of the electric bike 16. Thus, each product 11 is identifiable at least via the user ID in the system 10.

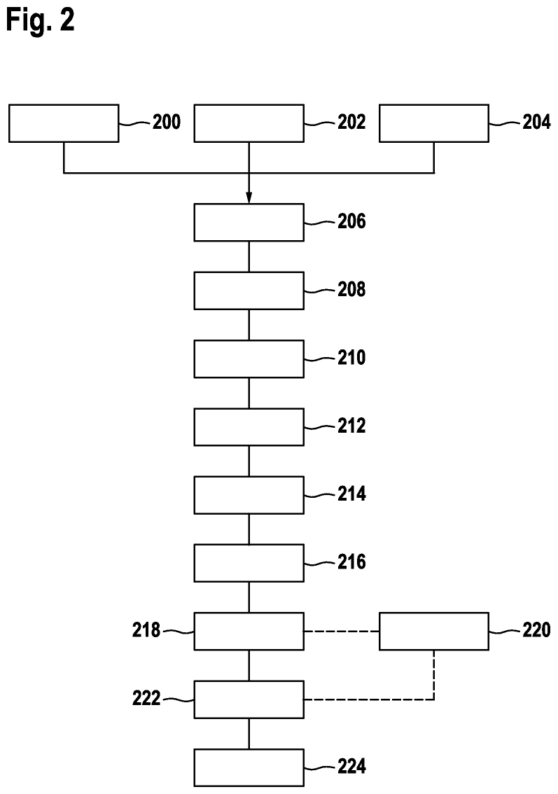

In FIG. 2, the method for providing information is shown in an example flowchart. The order of the steps is to be considered as an example. Individual method steps may be optional and/or may also be performed in a different order.

In a step 200, product information is provided to the backend 12 from the products 11. The product information comprises, by way of example, manufacturer information, via which the manufacturer of the product can be assigned. Also, by way of example, the product information comprises product category information that can be attributed to a category of the product. In the case of electric bikes, for example, the category may be configured as a cargo bike, a city bike, a gravel bike, a children's bike, a mountain bike for the trail, a trekking bike, a folding bike, or the like. Furthermore, the product information comprises, by way of example, manufacturing information, via which the year and/or the exact date of manufacture of the product or a component can be determined. In addition, the product information comprises, by way of example, a serial number for the product and/or for at least one, in particular all, components of the product. As an example, it is conceivable that the product as a whole has a serial number and that the individual components have additional serial numbers. The provision of the product information can be done indirectly via a mobile terminal 100 connected to the product 11 or directly through a connection of the product 11 to the backend 12.

In a further step 202, recipient information is provided to the backend 12. The recipient information comprises at least the user ID coupled to the product 11, preferably the serial number of the product 11. In addition, the recipient information preferably comprises a contact option for contacting the recipient. For example, the contact information may be configured as an email address or cellular phone number. The recipient may be the proprietor, owner, user, etc. of product 11. Furthermore, the recipient information comprises, by way of example, region information, wherein, using the region information, it is possible to determine in which region the product is used and/or is to be used. The recipient information is preferably provided only via the mobile terminal 100. However, it is also conceivable that the recipient information is also or only provided by product 11.

In a further step 204, at least one piece of usage information is provided to the backend 12. The usage information comprises, by way of example, an overall distance that the electric bike 16 has traveled so far. In addition, the usage information comprises, by way of example, an average route distance traveled by the electric bike 16. In addition, the usage information comprises a weekly usage number of the product 11. The usage information is preferably provided only via the mobile terminal 100. However, it is also conceivable that the recipient information is also or only provided by product 11.

The described product information, recipient information, and usage information are described in this combination by way of example only. Additional or different product information, recipient information, and usage information, as well as combinations, are also conceivable.

Steps 200, 202, 204 may be performed substantially simultaneously or independently of one another. The product information, recipient information, and usage information provided is associated with a product 11 and/or a recipient. The assignment can be made via a serial number of product 11, for example, and/or via a user ID. The product information, recipient information, and usage information for a product 11 may be merged prior to provision or after provision by the backend 12.

In a step 206, the product information, recipient information, and usage information provided is stored in the backend 12 and preferably evaluated.

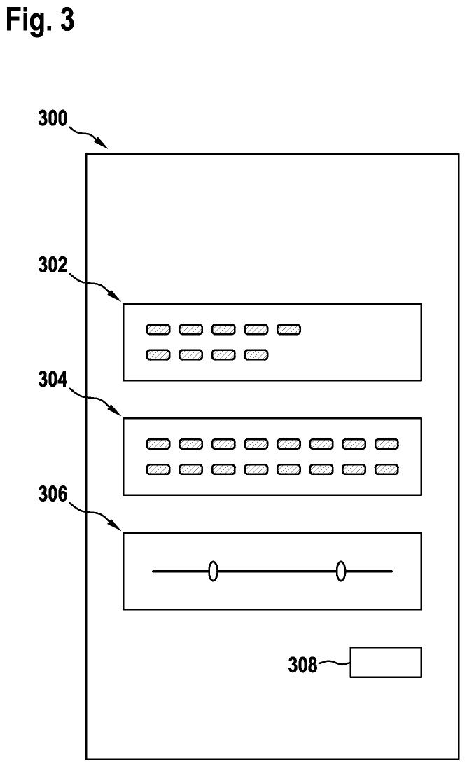

In a step 208, based on the product information, recipient information, and usage information of the products, a web interface 300 (see FIG. 3) is provided or adjusted. The web interface comprises, by way of example, at least three selection areas 302, 304, 306, wherein the selection areas are preferably determined based only on the product information, recipient information, and usage information. This means that without the product information at least one of the three selection areas is not determinable.

The first selection region 302 is exemplarily configured as an electric bike category. For example, the first selection area comprises the categories of cargo, city, fleet, gravel, children, mountain biking (tour), mountain bike (trail), folding bike, and trekking. As a result of the product information provided, each product 11 can be attributed to at least one of these categories.

For example, the second selection area 304 is configured as a geographic area, particularly a country in which the product 11 is currently being used. By means of the recipient information provided, each product 11 can be assigned location information in which it has been or will be used.

For example, the third selection area 306 is configured as an average weekly distance traveled with the product 11. The third selection area 306 comprises, by way of example, a slider with which a route area can be selected. The usage information provided allows each product 11 to be assigned a weekly distance traveled.

In a step 210, different recipient groups are determined. It is conceivable, as an example, that a first recipient group comprises all user IDs. Thus, all recipients or products 11 for the provision of information can be reached via the first recipient group. In addition, at least a second recipient group is determined, which is restricted compared to the first recipient group. The restriction is preferably made via the product information, preferably the manufacturer information. Preferably, a plurality of second recipient groups are determined, for example, a recipient group per manufacturer information or by bundling a plurality of manufacturer information. The second recipient groups are thus associated with different manufacturers. In addition, at least a third recipient group is determined by way of example. The at least one third recipient group thereby has, by way of example, a restriction in the form of further product information, which is configured as dealer information. The second recipient groups and the third recipient groups thus overlap partially or completely. The third recipient groups are associated with different distributors that distribute the products 11.

In a step 212, authentication of the sender 13 with the backend 12 takes place via the frontend 15. The connection between sender 13 and frontend 15 is preferably via the Internet. By providing authentication information of the sender 13 to the backend 12, the backend 12 determines which recipient group is assigned to the sender 13. If the sender 13 is, by way of example, associated with a manufacturer, the appropriate second recipient groups for the sender 13 are determined.

In a step 214, a specification is provided by the sender 13. The specification corresponds, by way of example, to a selection of the sender 13 in the web interface 300, in particular in the selection areas 302, 304, 306 of the web interface. The specification can ensure a targeted provision of information to a plurality of recipients. The specification can be selected and adjusted depending on the information on the part of the sender 13.

In an optional step 216, a variable of the recipient group 308 is determined on the part of the backend 12 and displayed in the web interface. Based on the variable of the recipient group 308, the specification of the sender 13 may again be adjusted. The variable 308 may be configured as an estimate or as an exact number of recipients.

In a further step 218, information is provided by the sender 13. The information is provided to provide to the plurality of recipients. For example, the information may be configured as a service notification or reminder, an event advertisement, a recall information, a product note, etc.

In a further step 220, a sender criterion is provided by the sender 13. The sender criterion is preferably configured as a further specification, which preferably dynamically restricts the recipient group and/or determines a point in time for provision of the information to the recipients. For example, the send criterion may be configured as a particular date and time. The send criterion may also be configured to reach a maximum daily number of kilometers ridden by the recipient.

In step 222, the information of the sender 13 or adapted information is provided to the plurality of recipients. The provision can be made directly to the product 11 or the mobile terminal 100 of the determined recipient. Alternatively, it is also conceivable that the provision of the information takes place on another communication channel, for example via email.

In a further optional step 224, feedback from the recipients regarding the information provided is determined and provided to the backend 12. For example, the feedback may be configured as a display duration of the information or another type of feedback, for example, following a link. Feedback is evaluated by the backend 12 and provided to the sender 13.

What is claimed is:

1. A method of providing information to a plurality of recipients, comprising:
providing product information to a backend;
providing recipient information to the backend;
providing usage information to the backend;
providing a specification and the information by a sender;
determining the plurality of recipients based on the product information, the recipient information, the usage information, and the specification; and
providing the information to the recipients determined.

2. The method according to claim 1, wherein the product information is provided by an electric bike.

3. The method according to claim 1, wherein the product information includes manufacturer information, dealer information, a bike ID, model information, year of manufacture, accessory information, electrical system information, and/or equipment information.

4. The method according to claim 1, wherein the recipient information is provided by the electric bike.

5. The method according to claim 1, wherein the recipient information comprises a user ID.

6. The method according to claim 1, wherein the recipient information comprises physical information related to the recipient.

7. The method according to claim 1, wherein the usage information is configured as electric bike usage information.

8. The method according to claim 1, wherein the usage information is configured as application software usage information.

9. The method according to claim 1, wherein the product information is static and the usage information is variable.

10. The method according to claim 1, wherein:
the determination of the recipients is made for at least two recipient groups,
the first recipient group comprises all user IDs, and
the second recipient group is restricted by the manufacturer information.

11. The method according to claim 1, wherein:
the determination of the recipients is made for an additional recipient group, and
the additional recipient group is restricted by the distributor information.

12. The method according to claim 1, wherein the specification comprises a product specification, a recipient specification, and/or a usage specification.

13. The method according to claim 1, wherein:
a send criterion is provided to the backend by the sender, and
the sending of the information to the determined recipient occurs based on the send criterion.

14. The method according to claim 1, wherein the information is displayed on a mobile terminal.

15. A method according to claim 1, wherein the information is displayed on an electric bike.

16. The method according to claim 1, wherein the product information is provided by a mobile terminal connected to an electric bike.

17. The method according to claim 1, wherein the recipient information is provided by a mobile terminal connected to an electric bike.

18. The method according to claim 1, wherein:
the usage information is configured as electric bike usage information, and
the usage information comprises a usage duration, a frequency of use, a location of use, a mode of use, a maintenance frequency, and/or wear information.

19. The method according to claim 1, wherein:
the usage information is configured as application software usage information, and
the usage information comprises a frequency of use or a mode of use of application software of a mobile terminal.

20. A method according to claim 1, wherein the information is displayed on a display screen of the electric bike or a mobile terminal connected to the electric bike.
